(19) United States
(12) Patent Application Publication
(10) Pub. No.: US 2021/0035115 A1
(43) Pub. Date: Feb. 4, 2021

(54) METHOD AND SYSTEM FOR PROVISIONING SOFTWARE LICENSES

(71) Applicant: EMC IP Holding Company LLC, Hopkinton, MA (US)

(72) Inventors: Amihai Savir, Sansana (IL); Assaf Natanzon, Tel Aviv (IL)

(21) Appl. No.: 16/526,349

(22) Filed: Jul. 30, 2019

(51) Int. Cl. G06Q 30/00; G06F 21/10; G06Q 30/02

(52) U.S. Cl. CPC G06Q 30/018; G06F 2221/0775; G06Q 30/0283; G06F 21/105

(57) ABSTRACT

A method and system for provisioning software licenses. Specifically, the method and system disclosed herein entail the intelligent provisioning of limited floating software licenses, available to an organization, based on cost analysis scoring measuring a risk associated with provisioning one of the floating software licenses to a license requestor. The cost analysis scoring may be derived from user productivity metrics, resource utilization metrics, user metadata, and project metrics.

### BACKGROUND

Many software products today require software licenses for full functionality activation. In procuring software licenses, organizations tend to adopt a hybrid license model, whereby a number of both named user licenses and floating software licenses are purchased.

### SUMMARY

In general, in one aspect, the invention relates to a method for managing software licenses. The method includes receiving, from a license pool manager, a cost analysis request including application license metadata and a set of user identifiers, computing a cost analysis score based at least on the application license metadata and the set of user identifiers, and delivering the cost analysis score to the license pool manager, to be used in a license provisioning assessment for a software license by the license pool manager.

In general, in one aspect, the invention relates to a system. The system includes a first computer processor configured to receive, from a second computer processor, a cost analysis request including application license metadata and a set of user identifiers, compute a cost analysis score based at least on the application license metadata and the set of user identifiers, and deliver the cost analysis score to the second computer processor, to be used in a license provisioning assessment for a software license by the second computer processor.

In general, in one aspect, the invention relates to a non-transitory computer readable medium (CRM). The non-transitory CRM includes computer readable program code, which when executed by a computer processor, enables the computer processor to receive, from a license pool manager, a cost analysis request including application license metadata and a set of user identifiers, compute a cost analysis score based at least on the application license metadata and the set of user identifiers, and deliver the cost analysis score to the license pool manager, to be used in a license provisioning assessment for a software license by the license pool manager.

Other aspects of the invention will be apparent from the following description and the appended claims.

### BRIEF DESCRIPTION OF DRAWINGS

FIG. 1 shows a system in accordance with one or more embodiments of the invention.

FIGS. 2A and 2B show flowcharts describing a method for computing a cost analysis score in accordance with one or more embodiments of the invention.

FIG. 3 shows a flowchart describing a method for processing a license request in accordance with one or more embodiments of the invention.

FIG. 4 shows a computing system in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

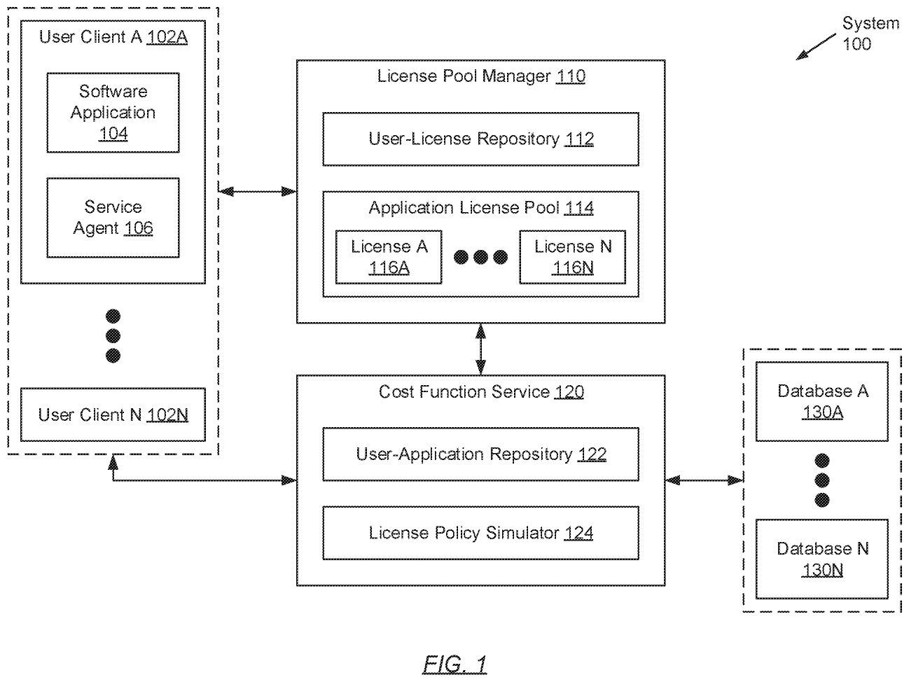

In the following description of FIGS. 1-4, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to a method and system for provisioning software licenses. Specifically, one or more embodiments of the invention entails the intelligent provisioning of limited floating software licenses, available to an organization, based on cost analysis scoring measuring a risk associated with provisioning one of the floating software licenses to a license requestor. The cost analysis scoring may be derived from user productivity metrics, resource utilization metrics, user metadata, and project metrics.

FIG. 1 shows a system in accordance with one or more embodiments of the invention. The system (100) may include one or more user clients (102A-102N), a license pool manager (110), a cost function service (120), and one or more databases (130A-130N). Each of these system (100) components is described below.

In one embodiment of the invention, the above-mentioned system (100) components may operatively connect to one another through a network (not shown) (e.g., a local area network (LAN), a wide array network (WAN) such as the Internet, a mobile network, etc.). The network may be implemented using any combination of wired and/or wireless connections. Further, the network may encompass various interconnected, network-enabled subcomponents (or systems) (e.g., switches, routers, gateways, etc.) that may facilitate communications between the above-mentioned system (100) components. Moreover, the above-mentioned system (100) components may communicate with one another using any combination of wired and/or wireless communication protocols.

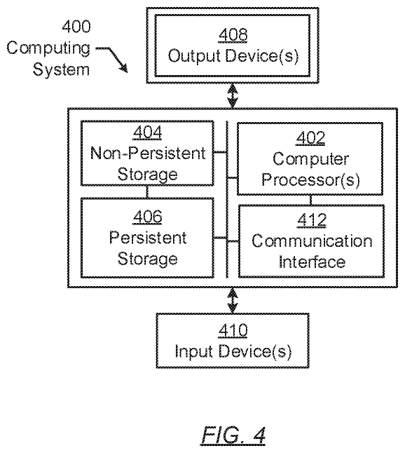

In one embodiment of the invention, a user client (102A-102N) may represent any physical appliance or computing system designed and configured to receive, generate, process, store, and/or transmit data, as well as to provide an environment in which one or more computer programs may execute thereon. The computer programs may, for example, implement large-scale and complex data processing; or implement one or more services offered locally or over a network. Further, in providing an execution environment for any computer programs installed thereon, a user client (102A-102N) may include and allocate various resources (e.g., computer processors, memory, storage, virtualization, network bandwidth, etc.), as needed, to the computer programs and the tasks (or processes) instantiated thereby. One of ordinary skill will appreciate that a user client (102A-102N) may perform other functionalities without departing from the scope of the invention. Examples of a user client (102A-102N) may include, but are not limited to, a desktop computer, a laptop computer, a tablet computer, a server, a mainframe, or any other computing system similar to the exemplary computing system shown in FIG. 4. Moreover, a user client (102A-102N) may include at least one software application (104) and a service agent (106) thereon. Each of these user client (102A-102N) subcomponents is described below.

In one embodiment of the invention, a software application (104) (also referred to as a user program) may refer to a computer program that may be executing on the underlying hardware of the user client (102A-102N). Specifically, a software application (104) may be designed and configured to perform one or more functions, tasks, and/or activities directed to aiding an operator (i.e., user) of the user client (102A-102N). Accordingly, towards performing these operations, a software application (104) may include functionality to request and consume user client (102A-102N) resources (e.g., computing, memory, storage, network bandwidth, etc.). One of ordinary skill will appreciate that a software application (104) may perform other functionalities without departing from the scope of the invention. Examples of a software application (104) may include, but are not limited to, a word processor, an email client, a database client, a web browser, a media player, a file viewer, an image editor, a simulator, a game, a big data analyzer, a machine learning based application, etc.

In one embodiment of the invention, a software application (104) may or may not require product activation. Product activation may refer to a license validation procedure required by some proprietary computer programs, whereby full functionality of the proprietary computer program may be limited or disabled until the aforementioned procedure successfully completes. Should a software application (104) require product activation, a product key, activation key, or software license—assigned to the user or software application (104) instance—may need to be authenticated to determine whether the software application (104) is being legally accessed according to a software end-user license agreements associated with the software application (104). Upon authentication of the product key, activation key, or software license, full functionality of the software application (104) may be unlocked.

In one embodiment of the invention, a software license for product activation may take form as a named user license or a floating software license. As the former, the software license may be assigned to a particular user and may allow the particular user access to the full functionality of the proprietary software at any time, regardless of the number of other users within their organization using the software product. On the other hand, as the latter, the software license may exist as one of multiple licenses maintained in a central pool of available licenses assigned to an organization, where the software license may be provisioned to a user associated with the organization based on availability and in response to a request. One or more embodiments of the invention described herein may be directed to this latter class of software license.

In one embodiment of the invention, the service agent (106) may refer to a computer program that may execute on the underlying hardware of the user client (102A-102N). Specifically, the service agent (106) may be designed and configured to aggregate and deliver user productivity and resource utilization metrics (described below). Collectively, these metrics may be referred herein as client-side indicators (CSI). Further, to that extent, the service agent (106) may include functionality to collect CSI periodically (or on-demand) through one or more physical and/or logical sensors integrated throughout the user client (102A-102N); and transmit the collected CSI to the cost function service (120). Moreover, when considering multiple users having access to a given user client (102A-102N) and multiple software applications (104) installed on the given user client (102A-102N), the service agent (106) may include functionality to, periodically (or on-demand), collect and deliver CSI for any given user-application pair.

In one embodiment of the invention, a user productivity metric may refer to a key performance indicator (KPI) used in the quantitative or qualitative measurement of the efficacy of a software application (104) user (i.e., operating the user client (102A-102N)) during their interaction with a given software application (104). Examples of a user productivity metric may include, but are not limited to, a power state (e.g., full on, standby, suspend, or off) associated with a monitor or screen of the user client (102A-102N), and input device (e.g., keyboard, mouse, etc.) usage patterns (e.g., mouse click rate, keystroke rate, average mouse click duration, average keystroke duration, etc.) performed by the user while the given software application (104) is exhibited in a foreground window on the user client (102A-102N). A user productivity metric is not limited to the aforementioned examples.

In one embodiment of the invention, a resource utilization metric, on the other hand, may refer to a KPI used in the quantitative or qualitative measurement of user client (102A-102N) resource usage by the given software application (104). Examples of a resource utilization metric may include, but are not limited to, a compute resource (e.g., central processing unit (CPU), graphics processing unit (GPU), random access memory (RAM), etc.) percentage allocated and consumed by the given software application (104), storage resource (e.g., storage disk, flash memory, etc.) access input-output (IO) patterns performed by the given software application (104), and a network resource (e.g., bandwidth, etc.) percentage allocated and consumed by the given software application (104). A resource utilization metric is not limited to the aforementioned examples.

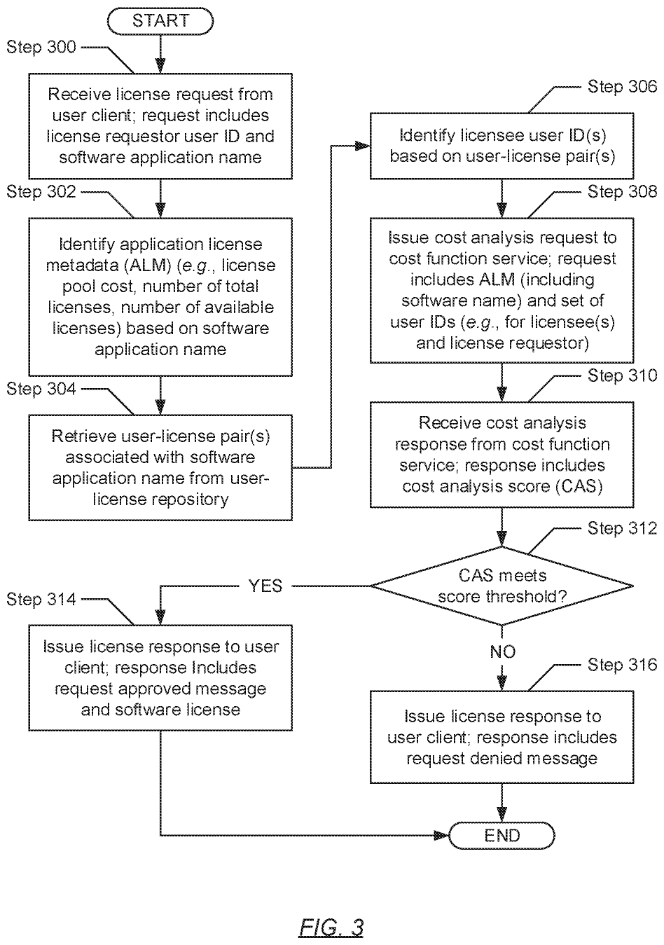

In one embodiment of the invention, the license pool manager (110) may represent a physical device (e.g., a server), a computer program executing on a physical device, or a combination thereof, which may be designed and configured to manage the provisioning of limited floating software licenses assigned to an organization. To that extent, the license pool manager (110) may include functionality to at least perform the various flowchart steps outlined and described in FIG. 3 below. One of ordinary skill will appreciate that the license pool manager (110) may perform other functionalities not disclosed in FIG. 3 without departing from the scope of the invention. Furthermore, the license pool manager (110) may include a user-license repository (112) and an application license pool (114). Each of these license pool manager (110) subcomponents is described below.

In one embodiment of the invention, the user-license repository (112) may refer to a data repository for storing user-license mappings (described below). The user-license repository (112) may be implemented using one or more physical or virtual storage devices (not shown), which may or may not be representative of the same type (or same storage technology). Further, the aforementioned user-license mappings consolidated in the user-license repository (112) may be arranged using any storage mechanism (e.g., a filesystem, a database, a collection of tables or records, etc.). Moreover, the user-license repository (112) may, at least in part, be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage media defined as non-volatile Storage Class Memory (SCM).

In one embodiment of the invention, a user-license mapping (also referred to as a user-license pair) may refer to a data tuple, or a finite ordered list (or sequence) of elements. More specifically, a user-license mapping may reflect an association between a given user (e.g., user client (102A-102N) operator, employee of an organization, etc.) and a given software license. The given software license may represent one of the multiple floating software licenses, assigned to an organization and maintained in the application license pool (114) (described below), for a given software application (104). Accordingly, a user-license mapping may represent a tracking object that tracks which floating software license has been provisioned to which user. A user or individual that is or has been provisioned a floating software license may also be referred herein as a licensee or existing licensee. Further, a user-license mapping may include the following elements: a user identifier (ID) or character string uniquely identifying the given user; and a license ID or character string uniquely identifying the given floating software license. In one embodiment of the invention, a user-license mapping may be indexed in the user-license repository (112) based on a software application name for the given software application (104) with which the floating software license (identified in the user-license mapping) is associated.

In one embodiment of the invention, the application license pool (114) may represent a data directory or a logical data container for storing one or more available software licenses (116A-116N). A software license (also referred to as a floating software license) (116A-116N) may refer to a licensing certificate (i.e., a digital file) directed to authenticating an instance of a given software application (104), thereby allowing the instance, and therefore a user interacting with the instance, access to the full functionality of the given software application (104). An available software license may refer to a software license that has yet to be provisioned to a given user. Furthermore, when considering the installation of multiple software applications (104) across the user client(s) (102A-102N), the application license pool (114) may store and index any available software licenses (116A-116N) for each software application (104) based on a software application name associated with the software application (104).

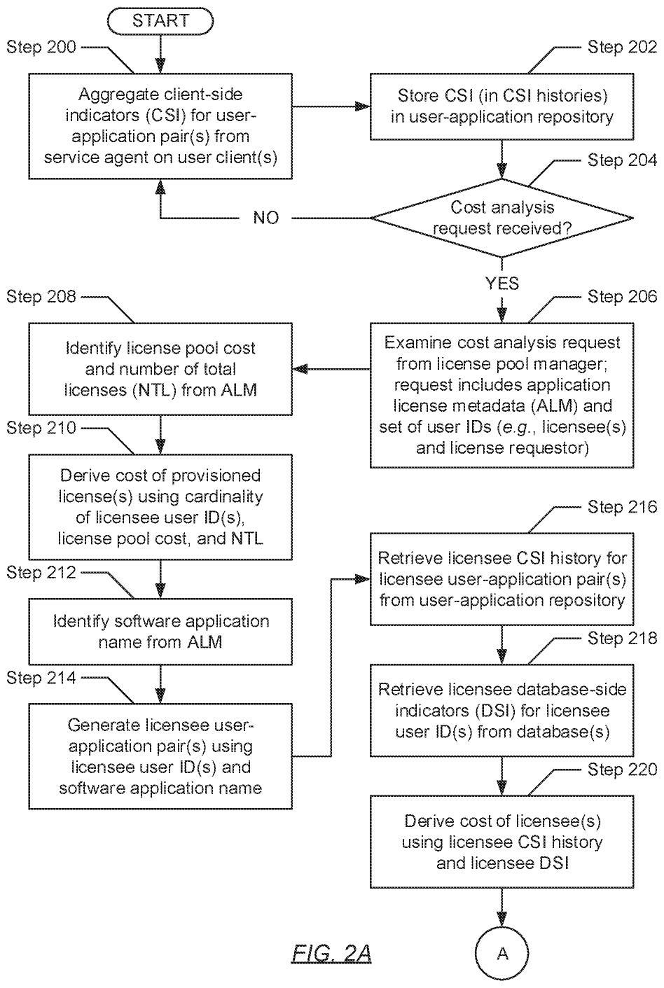

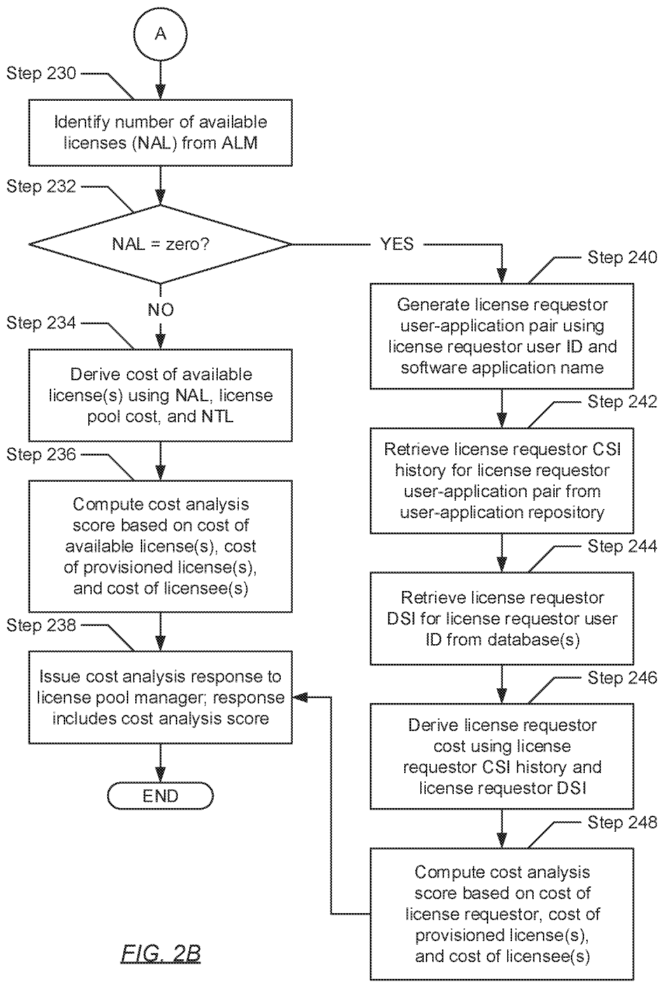

In one embodiment of the invention, the cost function service (120) may represent a physical device (e.g., a server), a computer program executing on a physical device, or a combination thereof, which may be designed and configured to compute cost analysis scores for which the provisioning of available floating software licenses may be based. To that extent, the cost function service (120) may include functionality to at least perform the various flowchart steps outlined and described in FIGS. 2A and 2B below. One of ordinary skill will appreciate that the cost function service (120) may perform other functionalities not disclosed in FIGS. 2A and 2B without departing from the scope of the invention. Furthermore, the cost function service (120) may include a user-application repository (122) and a license policy simulator (124). Each of these cost function service (120) subcomponents is described below.

In one embodiment of the invention, the user-application repository (122) may refer to a data repository for storing user-application mappings and one or more CSI histories (described below). The user-application repository (122) may be implemented using one or more physical or virtual storage devices (not shown), which may or may not be representative of the same type (or same storage technology). Further, the aforementioned user-application mappings and CSI histories consolidated in the user-application repository (122) may be arranged using any storage mechanism (e.g., a filesystem, a database, a collection of tables or records, etc.). Moreover, the user-application repository (122) may, at least in part, be implemented using persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage media defined as non-volatile Storage Class Memory (SCM).

In one embodiment of the invention, a user-application mapping (also referred to as a user-application pair) may refer to a data tuple, or a finite ordered list (or sequence) of elements. More specifically, a user-application mapping may reflect an association between a given user (e.g., user client (102A-102N) operator, employee of an organization, etc.) and a given software application (104). The given software application (104) may represent one of various software applications (104) installed across the user client(s) (102A-102N), which may require product activation (described above). Accordingly, a user-application mapping may represent a tracking object that tracks which user has exhibited interaction with which software application (104). Further, a user-application mapping may include the following elements: a user identifier (ID) or character string uniquely identifying the given user; and a software application name uniquely identifying the given software application (104). The software application name may refer to a character string that includes a product name and a product version or build associated with the given software application (104).

In one embodiment of the invention, a CSI history may refer to a multivariate time-series capturing collected values of CSI for a given user-application mapping and spanning multiple CSI sampling points in time. That is, a CSI history may encompass multiple time-series—i.e., multiple series of values indexed in a shared or common time order. Each time-series may reflect a series of sampled values directed to a different measurable variable—e.g., a different CSI.

In one embodiment of the invention, the license policy simulator (124) may refer to a computer program that may execute on any underlying hardware of the cost function service (120). Specifically, the license policy simulator (124) may be designed and configured to execute simulations directed to optimizing the license provisioning policy implemented by an organization. To that extent, the license policy simulator (124) may include functionality to configure and simulate various different license provisioning policies using the CSI histories, consolidated in the user-application repository (122) and other information stored in the database(s) (130A-130N) (described below). Each simulated license provisioning policy may be implemented through a machine learning model (e.g., neural networks, decision trees, support vector machines, etc.). Further, each simulated license provisioning policy may be differentiated from one another based on different values representative of a set of hyper-parameters defining the machine learning model—e.g., a number of floating software licenses procured by the organization, a policy for disconnecting users, a clustering of users into application license sub-pools, etc. Subsequently, the license policy simulator (124) may include further functionality to apply grid-searching over the various simulated license provisioning policies to ascertain the optimal values for the aforementioned set of hyper-parameters. In ascertaining these optimal hyper-parameter values, an optimal license provisioning policy may be identified for implementation by the organization.

In one embodiment of the invention, a database (130A-130N) may represent a data repository wherein various forms of information may be consolidated. A database (130A-130N) may be implemented using one or more servers (not shown). Each server may refer to a physical server, which may reside in a datacenter, or a virtual server, which may reside in a cloud computing environment. Additionally or alternatively, a database (130A-130N) may be implemented using one or more computing systems similar to the exemplary computing system shown in FIG. 4. Furthermore, a database (130A-130N) may further be implemented using one or more physical or virtual storage devices (not shown). Each storage device may store information in whole or in part, and temporarily or permanently. Moreover, at least a portion of the storage device(s) may include persistent (i.e., non-volatile) storage. Examples of persistent storage may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage media defined as non-volatile Storage Class Memory (SCM).

In one embodiment of the invention, a database (130A-130N) may store user (i.e., employee) metadata and project metrics, associated with an organization. Collectively, these metadata and/or metrics may be referred herein as database-side indicators (DSI). The DSI may be maintained by one or more individuals or employees associated with the organization such as, for example, a project manager, an accountant, a human resources manager, or any other individual that has access to and may store any of the aforementioned metadata and/or metrics (described below). Further, at least a portion of the DSI may be contributed by logical processes (e.g., computer programs) designed and configured to derive user and project metadata and/or metrics from two or more other user and/or project metadata and/or metrics.

In one embodiment of the invention, user metadata may refer to information descriptive of a user (e.g., user client (102A-102N) operator, employee of the organization, etc.) at least with respect to the organization with which the user may be associated. Examples of user metadata may include, but are not limited to, an user (or employee) level or rank assigned to the user, an occupation or job title associated with the user, and a user (or employee) salary associated with the user. User metadata is not limited to the aforementioned examples.

In one embodiment of the invention, a project metric may refer to a key performance indicator (KPI) used in the quantitative or qualitative measurement of the execution and budgeting of a project. A project, in turn, may be defined as an endeavor designed to produce a unique product, service, or result with one or more constraints—e.g., a time constraint, a budget constraint, a staffing constraint, etc.—that may be undertaken to achieve a unique goal or objective for the organization. Examples of a project metric may include, but are not limited to, statistics reflecting user (or employee) time applied to a project, a monetary budget allocated to a project, a current or actual monetary cost expended by a project, and statistics reflecting time delays or other issues associated with a project. A project metric is not limited to the aforementioned examples.

While FIG. 1 shows a configuration of components, other system configurations may be used without departing from the scope of the invention. For example, though the license pool manager (110) and the cost function service (120) may have been described above as residing on separate physical devices (e.g., servers (not shown)), in one embodiment of the invention, the license pool manager (110) and the cost function service (120) may be co-located on a same physical device (or server).

FIGS. 2A and 2B show flowcharts describing a method for computing a cost analysis score in accordance with one or more embodiments of the invention. The various steps outlined below may be performed by the cost function service (see e.g., FIG. 1). Further, while the various steps in the flowcharts are presented and described sequentially, one of ordinary skill will appreciate that some or all steps may be executed in different orders, may be combined or omitted, and some or all steps may be executed in parallel.

Turning to FIG. 2A, in Step 200, one or more indicator sets is/are aggregated. In one embodiment of the invention, an indicator set may refer to a collection of values—each representative of a different client-side indicator (CSI) (described above—see e.g., FIG. 1). Further, any given indicator set may reflect CSI values for a given user-application pair (i.e., for a given user interacting with a given software application executing on a given user client), where the given indicator set had been collected, by a service agent residing on the given user client, at a given timestamp or point in time.

In Step 202, the indicator set(s) (aggregated in Step 200) is/are stored in a user-application repository (described above—see e.g., FIG. 1). Specifically, in one embodiment of the invention, each above-mentioned indicator set may be appended to their respective CSI history (described above) stored in the user-application repository. CSI histories may be indexed (or searchable) in the user-application repository using a corresponding user-application mapping (or pair).

In Step 204, a determination is made as to whether a cost analysis request has been received. A cost analysis request, issued by a license pool manager (described above—see e.g., FIG. 1), may represent a service request directed to calculating and returning a cost analysis score (described below). In one embodiment of the invention, if it is determined that a cost analysis request has been received, then the process may proceed to Step 206. On the other hand, in another embodiment of the invention, if it is alternatively determined that a cost analysis request has not been received, then the process may alternatively proceed to Step 200, where the aggregation of client-side indicators for one or more user-application pairs continues.

In Step 206, after determining (in Step 204) that a cost analysis request has been received from the license pool manager, the cost analysis request is examined. In one embodiment of the invention, examination of the cost analysis request may reveal contents enclosed thereby, which may include application license metadata (ALM) and a set of user identifiers (IDs). The application license metadata may refer to information descriptive of a given software application (for which a floating software license associated therewith is being requested) and the floating license pool maintained for the given software application. The aforementioned information may include, but is not limited to, a software application name, a license pool cost, a number of total licenses (NTL), and a number of available licenses (NAL). The software application name may refer to a character string that reflects a product name and product version or build associated with the given software application. The license pool cost may refer to a numerical value that reflects the monetary valuation of the floating license pool—i.e., a combined monetary valuation of all floating software licenses, procured by an organization, for the given software application. The number of total licenses may refer to a numerical value that reflects a cardinality of a set of floating software licenses procured and, thereby, assigned to the organization. The number of available licenses may refer to a numerical value that reflects a cardinality of a set of floating software licenses, assigned to the organization, that have yet to be provisioned to a user of the organization.

Furthermore, in one embodiment of the invention, a user identifier may refer to a character string that uniquely identifies a user of the given software application within the organization (e.g., an employee identifier). More specifically, the set of user identifiers may include a user identifier associated with a license requestor (also referred to as a license requestor user ID) and at least one user identifier associated with at least one existing licensee (also referred to as a licensee user ID). The license requestor may refer to an individual (i.e., employee of the organization) whom may be requesting access to one of the floating software licenses, assigned to the organization, for the given software application. Alternatively, an existing licensee may refer to an individual (i.e., employee of the organization) whom has already been provisioned one of the floating software licenses, assigned to the organization, for the given software application.

In Step 208, the above-mentioned license pool cost and number of total licenses are identified and extracted from the application license metadata (revealed in Step 206). In Step 210, a cost of all provisioned floating software licenses (also referred to as the provisioned licenses cost) is derived. In one embodiment of the invention, the provisioned licenses cost may refer to a numerical value that reflects a combined monetary valuation of the floating software license(s), assigned to the organization, for the given software application, which has/have already been provisioned. Further, the provisioned licenses cost may be derived using a cardinality of the set of licensee user IDs, the license pool cost, and the number of total licenses (all received via the cost analysis request in Step 206). For example, provisioned licenses cost=(license pool cost/number of total licenses)×number of licensee user IDs (i.e., cardinality of the set of licensee user IDs).

In Step 212, the above-mentioned software application name is identified and extracted from the application license metadata (revealed in Step 206). In Step 214, one or more licensee user-application pairs is/are generated. In one embodiment of the invention, a licensee user-application pair may refer to a data tuple, or a finite ordered list (or sequence) of elements. More specifically, a licensee user-application pair may reflect a mapping associating a given licensee and the given software application. Accordingly, each licensee user-application pair may refer to a data tuple that includes the licensee user ID for a given existing licensee of the given software application as a first element, and the software application name (identified in Step 212) as a second element.

In Step 216, one or more CSI histories is/are retrieved from the user-application repository. That is, in one embodiment of the invention, a CSI history may be obtained for each licensee user-application pair (generated in Step 214) (also referred to as licensee CSI history). Subsequently, in Step 218, database-side indicators are retrieved from one or more databases (described above—see e.g., FIG. 1). That is, in one embodiment of the invention, a set of database-side indicators (also referred to as licensee DSI) may be obtained for each licensee user-application pair (generated in Step 214).

In Step 220, a cost of all existing licensees of the given software application (also referred to as the licensees cost) is derived. In one embodiment of the invention, the licensees cost may refer to a numerical value that reflects a combined monetary valuation of the user(s) (i.e., employees) that have already been provisioned a floating software license for the given software application. Further, the licensees cost may be derived using the one or more licensee CSI histories (retrieved in Step 216) and the licensee DSI(s) (retrieved in Step 218). For example, licensees cost=Σ[(hourly licensee rate×licensee hours billed to project)+project delay fees] for all existing licensees. From here, the process proceeds to Step 230 (see e.g., FIG. 2B).

Turning to FIG. 2B, in Step 230, the above-mentioned number of available licenses is identified and extracted from the application license metadata (revealed in Step 206). In Step 232, a determination is made as to whether the number of available licenses (identified in Step 230) reflects a zero value. Accordingly, in one embodiment of the invention, if it is determined that the number of available licenses equals zero, then the process may proceed to Step 240. On the other hand, in another embodiment of the invention, if it is alternatively determined that the number of available licenses reflects a non-zero value, then the process may alternatively proceed to Step 234.

In Step 234, after determining (in Step 232) that the number of available licenses (identified in Step 230) reflects a non-zero value, a cost of all available floating software licenses (also referred to as the available licenses cost) is derived. In one embodiment of the invention, the available licenses cost may refer to a numerical value that reflects a combined monetary valuation of the floating software license(s), assigned to the organization, for the given software application, which has/have yet to be provisioned. Further, the available licenses cost may be derived using the number of available licenses, the license pool cost, and the number of total licenses (all received via the cost analysis request in Step 206). For example, available licenses cost=(license pool cost/number of total licenses)×number of available licenses.

In Step 236, a cost analysis score is computed. In one embodiment of the invention, the cost analysis score may refer to a metric that reflects the risk associated with provisioning one of the floating software licenses, assigned to the organization, for the given software application to the license requestor. Further, the cost analysis score may be computed based on the available licenses cost (derived in Step 234), the provisioned licenses cost (derived in Step 210), and the licensees cost (derived in Step 220). For example, cost analysis score=available licenses cost+(provisioned licenses cost−licensees cost).

In Step 238, a cost analysis response is issued. In one embodiment of the invention, the cost analysis response may represent a reply to the cost analysis request (determined to have been received in Step 204) and, accordingly, may be directed to the license pool manager. Further, the cost analysis response may include the cost analysis score (computed in Step 236 or Step 248).

In Step 240, after alternatively determining (in Step 232) that the number of available licenses (identified in Step 230) reflects a zero value, a license requestor user-application pair is generated. In one embodiment of the invention, the license requestor user-application pair may refer to a data tuple, or a finite ordered list (or sequence) of elements. More specifically, the license requestor user-application pair may reflect a mapping associating the license requestor and the given software application. Accordingly, the license requestor user-application pair may refer to a data tuple that includes the license requestor user ID for the license requestor of the given software application as a first element, and the software application name (identified in Step 212) as a second element.

In Step 242, a CSI history is retrieved from the user-application repository. That is, in one embodiment of the invention, a CSI history may be obtained for the license requestor user-application pair (generated in Step 240) (also referred to as the license requestor CSI history). Subsequently, in Step 244, database-side indicators are retrieved from one or more databases. That is, in one embodiment of the invention, a set of database-side indicators (also referred to as license requestor DSI) may be obtained for the license requestor user-application pair (generated in Step 244).

In Step 246, a cost of the license requestor of the given software application (also referred to as the license requestor cost) is derived. In one embodiment of the invention, the license requestor cost may refer to a numerical value that reflects a combined monetary valuation of the user (i.e., employee) requesting to be provisioned a floating software license for the given software application. Further, the license requestor cost may be derived using the license requestor CSI history (retrieved in Step 242) and the license requestor DSI (retrieved in Step 244). For example, license requestor cost=(hourly license requestor rate×license requestor hours billed to project)+project delay fees.

In Step 248, a cost analysis score is computed. In one embodiment of the invention, the cost analysis score may refer to a metric that reflects the risk associated with provisioning one of the floating software licenses, assigned to the organization, for the given software application to the license requestor. Further, the cost analysis score may be computed based on the license requestor cost (derived in Step 246), the provisioned licenses cost (derived in Step 210), and the licensees cost (derived in Step 220). For example, cost analysis score=license requestor cost+(provisioned licenses cost−licensees cost). Hereinafter, the process proceeds to Step 238, where a cost analysis response, including the cost analysis score (computed in Step 248), is issued to the license pool manager.

FIG. 3 shows a flowchart describing a method for processing a license request in accordance with one or more embodiments of the invention. The various steps outlined below may be performed by the license pool manager (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 3, in Step 300, a license request is received from a user client (described above—see e.g., FIG. 1). In one embodiment of the invention, the license request may pertain to the provisioning of one of the floating software licenses, assigned to an organization, for a given software application. Further, the license request may include a license requestor user identifier (ID) and a software application name The license requestor user ID may refer to a character string that uniquely identifies a license requestor and user of the given software application within the organization (e.g., an employee identifier). The license requestor may refer to an individual (i.e., employee of the organization) whom may be requesting access to one of the floating software licenses, assigned to the organization, for the given software application. On the other hand, the software application name may refer to a character string that reflects a product name and product version or build associated with the given software application.

In Step 302, application license metadata (ALM), for the given software application, is identified based on the software application name (received via the license request in Step 300). In one embodiment of the invention, application license metadata may refer to information descriptive of a given software application (for which a floating software license associated therewith is being requested) and the floating license pool maintained for the given software application. The aforementioned information may include, but is not limited to, a license pool cost, a number of total licenses (NTL), and a number of available licenses (NAL). The license pool cost may refer to a numerical value that reflects the monetary valuation of the floating license pool—i.e., a combined monetary valuation of all floating software licenses, procured by an organization, for the given software application. The number of total licenses may refer to a numerical value that reflects a cardinality of a set of floating software licenses procured and, thereby, assigned to the organization. The number of available licenses may refer to a numerical value that reflects a cardinality of a set of floating software licenses, assigned to the organization, that have yet to be provisioned to a user of the organization.

In Step 304, one or more user-license pairs is/are retrieved from a user-license repository (described above—see e.g., FIG. 1). In one embodiment of the invention, the user-license pair(s) may be identified as those, stored in the user-license repository, which may be associated with the software application name (received via the license request in Step 300). Further, a user-license pair may refer to a data tuple, or a finite ordered list (or sequence) of elements. More specifically, a user-license pair may reflect a mapping or an association between a given existing licensee and a given floating software license for a given software application. An existing licensee may refer to an individual (i.e., employee of the organization) whom has already been provisioned one of the floating software licenses, assigned to the organization, for the given software application. Accordingly, a user-license pair may refer to a data tuple that includes the licensee user ID for a given existing licensee of the given software application as a first element, and a license ID for a given floating software license associated with a given software application as a second element. The licensee user ID may refer to a character string that uniquely identifies the given existing licensee, whereas the license ID may refer to a character string that uniquely identifies the given floating software license.

In Step 306, one or more licensee user IDs is/are identified. That is, in one embodiment of the invention, from each user-license pair (retrieved in Step 304), a licensee user ID, specified therein, may be identified. In Step 308, a cost analysis request is issued. In one embodiment of the invention, the cost analysis request may represent a service request, which may be directed to a cost function service (described above—see e.g., FIG. 1). Further, the cost analysis request may include the application license metadata (identified in Step 302), including the software application name (received via the license request in Step 300), and a set of user IDs. Specifically, the set of user IDs may include the user identifier associated with the above-mentioned license requestor (also referred to as the license requestor user ID) (received in Step 300) and at least one user identifier associated with at least one above-mentioned existing licensee (also referred to as a licensee user ID) (identified in Step 306).

In Step 310, a cost analysis response is subsequently received. In one embodiment of the invention, the cost analysis response may represent a reply to the cost analysis request (issued in Step 308) and, accordingly, may have been received from the cost function service. Further, the cost analysis response may include a cost analysis score. The cost analysis score may refer to a metric that reflects the risk associated with provisioning one of the floating software licenses, assigned to the organization, for the given software application to the license requestor.

In Step 312, a determination is made as to whether the cost analysis score (received via the cost analysis response in Step 310) meets a cost analysis score threshold. The cost analysis score threshold may represent a configurable value reflective of a prescribed, acceptable (or sufficiently low) risk score to which the cost analysis score, for any given license requestor, is compared. Further, the cost analysis score threshold may be configured by an administrator of the license pool manager. Moreover, the determination and either of the steps (i.e., Step 314 or Step 316) following hereinafter may be collectively referred to as a license provisioning assessment. Accordingly, in one embodiment of the invention, if it is determined that the cost analysis score meets or satisfies the cost analysis score threshold, then the process may proceed to Step 314. On the other hand, in another embodiment of the invention, if it is alternatively determined that the cost analysis score does not meet or does not satisfy the cost analysis score threshold, then the process may alternatively proceed to Step 316.

In Step 314, after determining (in Step 312) that the cost analysis score (received via the cost analysis response in Step 310) meets the above-mentioned cost analysis score threshold, a license response is issued. In one embodiment of the invention, the license response may represent a reply to the license request (received in Step 300) and, accordingly, may be directed to the above-mentioned user client. Further, the license response may include a request approved message informing the license requestor that their submitted license request has been approved at this given time; and a licensing certificate (i.e., a digital file) representative of one of the floating software licenses, assigned to the organization, for the given software application.

In Step 316, after alternatively determining (in Step 312) that the cost analysis score (received via the cost analysis response in Step 310) fails to meet the above-mentioned cost analysis score threshold, a license response is issued. In one embodiment of the invention, the license response may represent a reply to the license request (received in Step 300) and, accordingly, may be directed to the above-mentioned user client. Further, the license response may include a request denied message informing the license requestor that their submitted license request has been denied at this given time.

FIG. 4 shows a computing system in accordance with one or more embodiments of the invention. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one embodiment of the invention, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for managing software licenses, comprising:
receiving, from a license pool manager, a cost analysis request comprising application license metadata and a set of user identifiers;
computing a cost analysis score based at least on the application license metadata and the set of user identifiers; and
delivering the cost analysis score to the license pool manager, to be used in a license provisioning assessment for a software license by the license pool manager.

2. The method of claim 1, wherein the application license metadata comprises a software application name, a license pool cost, a number of total licenses, and a number of available licenses.

3. The method of claim 2, wherein computing the cost analysis score, comprises:
deriving a provisioned licenses cost using a cardinality of a subset of the set of user identifiers, the license pool cost, and the number of total licenses;
deriving a licensees cost based on at least one licensee client-side indicator history and at least one set of licensee database-side indicators;
making a determination that the number of available licenses reflects a non-zero value;
based on the determination:
deriving an available licenses cost using the number of available licenses, the license pool cost, and the number of total licenses; and
computing the cost analysis score based on the available licenses cost, the provisioned licenses cost, and the licensees cost.

4. The method of claim 3, wherein the subset of the set of user identifiers comprises at least one licensee user identifier.

5. The method of claim 4, wherein deriving the licensees cost, comprises:
for each licensee user identifier of the at least one licensee user identifier:
generating a licensee user-application pair comprising the licensee user identifier and the software application name;
obtaining a licensee client-side indicator history associated with the licensee user-application pair;
obtaining a set of licensee database-side indicators associated with the licensee user-application pair;
deriving an individual licensee cost based on the licensee client-side indicator history and the set of licensee database-side indicators; and
combining the individual licensee cost, for each licensee user identifier of the at least one licensee user identifier, to derive the licensees cost.

6. The method of claim 5, wherein the licensee client-side indicator history comprises a multivariate time-series reflecting multiple user productivity and resource utilization metrics.

7. The method of claim 5, wherein the set of licensee database-side indicators comprises multiple user metadata and project metrics.

8. The method of claim 2, wherein computing the cost analysis score, comprises:
deriving a provisioned licenses cost using a cardinality of a first subset of the set of user identifiers, the license pool cost, and the number of total licenses;
deriving a licensees cost based on at least one licensee client-side indicator history and at least one set of licensee database-side indicators;
making a determination that the number of available licenses reflects a zero value;
based on the determination:
deriving a license requestor cost based a second subset of the set of user identifiers; and
computing the cost analysis score based on the license requestor cost, the provisioned licenses cost, and the licensees cost.

9. The method of claim 8, wherein the second subset of the set of user identifiers comprises a license requestor user identifier.

10. The method of claim 9, wherein deriving the license requestor cost, comprises:
generating a license requestor user-application pair comprising the license requestor user identifier and the software application name;
obtaining a license requestor client-side indicator history associated with the license requestor user-application pair;
obtaining a set of license requestor database-side indicators associated with the license requestor user-application pair; and
deriving the license requestor cost based on the license requestor client-side indicator history and the set of license requestor database-side indicators.

11. The method of claim 2, wherein the software license is a floating software license of a plurality of floating software licenses for a software application associated with the software application name

12. The method of claim 1, wherein the license provisioning assessment, comprises:
making a determination that the cost analysis score satisfies a cost analysis score threshold; and
based on the determination:
approving a provision of the software license to a license requestor.

13. The method of claim 1, wherein the license provisioning assessment, comprises:
making a determination that the cost analysis score fails to satisfy a cost analysis score threshold; and
based on the determination:
denying a provision of the software license to a license requestor.

14. A system, comprising:
a first computer processor configured to:
receive, from a second computer processor, a cost analysis request comprising application license metadata and a set of user identifiers;
compute a cost analysis score based at least on the application license metadata and the set of user identifiers; and
deliver the cost analysis score to the second computer processor, to be used in a license provisioning assessment for a software license by the second computer processor.

15. The system of claim 1, wherein the first computer processor resides in a first server and the second computer processor resides in a second server operatively connected to the first server.

16. The system of claim 1, wherein the first computer processor and the second computer processor are co-located in a same server.

17. The system of claim 1, further comprising:
a data repository operatively connected to the first computer processor, and comprising user-license mappings; and
a software license pool managed by the first computer processor, and comprising a plurality of software licenses.

18. The system of claim 1, further comprising:
a data repository operatively connected to the second computer processor, and comprising user-application mappings; and
a license policy simulator executing on the second computer processor, and configured to perform simulations directed to optimizing a license provisioning policy.

19. The system of claim 1, further comprising:
a third computer processor operatively connected to the first and second computer processors; and
a software application executing on the third computer processor,
wherein the software application requires the software license to unlock full functionality.

20. A non-transitory computer readable medium (CRM) comprising computer readable program code, which when executed by a computer processor, enables the computer processor to:
receive, from a license pool manager, a cost analysis request comprising application license metadata and a set of user identifiers;
compute a cost analysis score based at least on the application license metadata and the set of user identifiers; and
deliver the cost analysis score to the license pool manager, to be used in a license provisioning assessment for a software license by the license pool manager.
